(19) United States
(12) Patent Application Publication
(10) Pub. No.: US 2007/0123258 A1
(43) Pub. Date: May 31, 2007

(54) Mobile terminal autonomous handoff for unidirectional mobile communication

(76) Inventor: Francois Sawyer, St-Hubert (CA)

Correspondence Address: Sandra Beauchesne;Ericsson Canada Inc., Patent Department, 8400 Decarie Blvd., Town Mount Royal, QC, H4P 2N2, CA

(21) Appl. No.: 11/289,576

(22) Filed: Nov. 30, 2005

(51) Int. Cl. H04Q 7/20

(52) U.S. Cl. 455/436

(57) ABSTRACT

A method and a mobile receiver are provided for autonomous handoff at the mobile receiver in support for unidirectional transmission from fixed servers. The mobile receiver selects a broadcast server on which it then receives a designation for a downlink traffic channel which is not paired with an uplink traffic channel. Data and neighbor server information are received at the mobile receiver. The mobile receiver autonomously reselects a new server when it moves closer to the new server which now provides a better signal quality.

### BACKGROUND OF THE INVENTION

1. Field of the Invention

The present invention relates to a method and a mobile receiver for autonomous handoff control at the mobile receiver in support of unidirectional communication between servers and the mobile receiver.

2. Description of the Related Art

Mobile communication networks use Radio Base Stations (RBS) as servers to provide bidirectional communication with mobile terminals. Bidirectional communication provides support for traditional voice services and for recent advances such as packet data services or videoconferencing. A small number of unidirectional services are available. For example, broadcast Short Message Service (SMS) can be used to send a short alphanumeric message towards an unlimited number of mobile terminals. However, the broadcast SMS can only be sent on a broadcast channel with a typical maximum length in the order of one or two hundred alphanumeric characters, depending on the air interface standard in use. Hence, unidirectional service capabilities of mobile communication networks are severely limited.

Reference is now made to FIG. 1, which shows a mobile terminal 100 and two proximally located servers, or RBSs 110 and 120, as known in the art of mobile cellular communications. Both RBSs transmit on at least two channels, at least one channel per RBS being used for broadcast of parameters, respectively referenced by numerals 112 and 122, and at least one but preferably a plurality of channels per RBS being used as downlink traffic channels, also called forward traffic channels, respectively referenced by numerals 114 and 124. Depending on the air interface in use, the at least two channels per RBS may operate using distinct frequencies, distinct timeslots or distinct channel codes, or combinations of frequencies, timeslots and codes. Those of ordinary skills in the art will appreciate that the hereinabove description of FIG. 1, which mentions at least one channel for broadcast and at least one channel for downlink traffic, relate to a case of omni directional transmission by the RBSs wherein one RBS has one coverage area or cell. As it is well known in the art, RBSs may comprise directional antennas to provide sectorized coverage wherein each sector comprise a coverage area for at least one broadcast channel and at least one downlink traffic channel. Hence, a single RBS may provide one or several coverage areas or cells.

To support voice or data traffic, the RBS 110 or 120 allocates a traffic channel pair to a given mobile terminal 100, said traffic channel pair comprising a downlink traffic channel and an uplink traffic channel. While it is receiving on the downlink traffic channel 114 or 124, the mobile terminal 100 also transmits towards the RBS on an uplink traffic channel 118 or 128, also called reverse link traffic channel. The uplink traffic channel 118 or 128 is of a same nature as that of the downlink traffic channel 114 or 124. Generally, the uplink and downlink traffic channels are separated by a fixed frequency separation. In some air interfaces supporting Time Division Duplex (TDD), the uplink and downlink traffic channels share a same frequency, but occupy distinct timeslots. Bidirectional communication is achieved by allocating to the mobile terminal 100 a downlink traffic channel 114 or 124 paired with an uplink traffic channel 118 or 128.

In the case of Time Division Multiple Access (TDMA) RBSs, each cell comprises a control channel 112 or 122 on a first timeslot of a first radio frequency, the control channel being used for broadcasting parameters. Each cell further comprises at least one downlink traffic channel 114 or 124, which is either found on a second timeslot of the same first radio frequency, or on a timeslot of another radio frequency. Each downlink traffic channel 114 or 124 is paired with an uplink traffic channel 118 or 128. Two or more TDMA cells comprise distinct frequency sets, in order to avoid interference. The mobile terminal 100 is capable of tuning on any frequency supported by the two cells and is further capable of selecting any timeslot on any such frequency. The mobile terminal 100 is capable of decoding parameters broadcasted on the control channels 112 and 122 as well as decoding a content of the downlink traffic channels 114 and 124. The parameters broadcasted on the control channel 112 or 122 of each cell comprise a list of measurement channels of the neighboring cells. The control channels 112 and 122 can send information dedicated to a given mobile terminal, comprising for example a traffic channel designation used to assign the downlink traffic channel 114 or 124, paired with the uplink traffic channel 118 or 128, to the mobile terminal 100 at the beginning of a call. The content of the uplink and downlink traffic channels typically comprise voice or data, but the downlink traffic channels 114 and 124 also comprises a list of measurement channels of the neighboring cells. A measurement channel of a cell can be any radio frequency continuously transmitted on that cell. The measurement channel is typically, but not necessarily, the frequency that carries the control channel 112 or 122 for that cell.

In the case of Code Division Multiple Access (CDMA) RBSs, each cell comprises a pilot channel 116 or 126, at least one paging channel 112 or 122 and at least one downlink traffic channel 114 or 124. Each downlink traffic channel 114 or 124 is paired with an uplink traffic channel 118 or 128. The pilot channels 116 and 126 are used to help the mobile terminal 100 in quickly locating the cell. The paging channels 114 and 124 are used for broadcasting parameters. In a cell, on a same frequency, the pilot channel 116 or 126, one or several paging channels 112 or 122 and one or more downlink traffic channels 114 or 124 paired with uplink traffic channels 114 or 124 are distinguished by use of channelization codes (not shown), such as for instance Walsh codes or mobile specific pseudo random noise sequences. Downlink and uplink transmission for two or more CDMA cells is typically on a same frequency pair, but cells that share the same frequency pair are separated by distinct cell specific pseudo random sequence codes (not shown), in order to avoid interference. The mobile terminal 100 is capable of tuning on any frequency supported by the two cells and is further capable of selecting any channel based on the channel's channelization code and pseudo random sequence, on any such frequency. The mobile terminal 100 is capable of decoding parameters broadcasted on the paging channels 112 and 122 as well as decoding a content of any downlink traffic channel 114 and 124. The parameters broadcasted on the paging channel 112 or 122 of each cell comprise a list of pilot channels 116 and 126 of the neighboring cells. The paging channels 112 and 122 can also send information dedicated to a given mobile terminal, comprising for example a traffic channel designation used to assign the downlink traffic channel 114 or 124 paired with the uplink traffic channel 118 or 128 to the mobile terminal 100 at the beginning of a call. The content of the uplink and downlink traffic channels typically comprises voice or data, but the downlink traffic channels 114 and 124 also comprises a list of pilot channels 116 and 126 of the neighboring cells. In CDMA, the pilot channels 116 and 126 of the neighboring cells are effectively used as measurement channels for those cells.

Whether communication between RBSs and the mobile terminal 100 is effectuated by use of TDMA or CDMA, the mobile terminal 100 has a capability of evaluating the signal strength of downlink channels in the cell it is currently selecting as well as the signal strength of downlink channels in the neighboring cells. When the mobile terminal 100 is busy, receiving a downlink traffic channel 114 or 124 paired with an uplink traffic channel 118 or 128 on which it is transmitting, it conventionally provides signal strength measurements to the mobile communication network. The mobile terminal 100 transmits its signal strength measurements on the reverse traffic channel 118 or 128. The signal strength measurements are used, in a concept known as Mobile Assisted Hand Off (MAHO), as a means to assist cell reselection for the mobile terminal 100 by the mobile communication network. A network node of the mobile communication network, in control of the RBSs, takes any handoff decision and allocates a traffic channel pair in a new cell to the mobile terminal 100, based in part on the MAHO measurements.

Unidirectional transmission from a RBS may be received by an unlimited number of mobile terminals. However, unidirectional traffic channel designation to those mobile terminals is not specified in the prior art. As well, cell reselection when those mobile terminals move around remains a problem since the MAHO concept relies on bidirectional communication between servers and mobile terminals. MAHO cannot support a system wherein unidirectional transmission would be effectuated from the servers towards a mobile receiver. There would be clear advantages of having a method and a mobile receiver for supporting unidirectional traffic channel assignment and cell reselection where unidirectional service can be provided from servers towards the mobile receiver.

### SUMMARY OF THE INVENTION

It is therefore a broad object of this invention to provide a method and a mobile receiver for effectuating unidirectional traffic channel assignments for communication service in the downlink direction only, wherein server reselection decisions are made within the mobile receiver, based on information provided to the mobile receiver about servers. Such method and mobile receiver are used for unidirectional services between the servers and the mobile terminal and are of particular interest for large contents or for continuously transmitted contents.

A first aspect of the present invention is directed to a method for unidirectional transmission service from fixed servers to a mobile receiver. The mobile receiver receives on a broadcast channel a traffic channel designation for an unpaired downlink traffic channel. While the mobile receiver receives data on the unpaired downlink traffic channel, it also receives information on the neighboring servers in the form of a measurement channel for each server. The mobile receiver compares a signal quality of the first server with those of the neighbor servers and autonomously reselects a new server with better signal quality. On the new server, the mobile receiver receives a new unpaired downlink traffic channel designation. The method for unidirectional transmission from fixed servers to the mobile receiver is applicable to TDMA and to CDMA air interfaces. Neighbor servers may transmit the same or distinct data, as applicable to an application of the unidirectional service.

In a second aspect of the present invention, the mobile receiver additionally receives on the unpaired downlink traffic channel a downlink traffic channel identity for each of the neighbor servers. The mobile receiver upon reselection of a new server uses the downlink traffic channel identity for that new server to select the unpaired downlink traffic channel.

In a third aspect of the present invention, the mobile receiver uses signal strength measurements on downlink channels to evaluate signal quality of the servers.

In a fourth aspect of the present invention, the mobile receiver averages signal strength measurements for a brief period before making comparisons and adds a hysteresis to the present server's signal strength.

In a fifth aspect of the present invention, though the mobile receiver is capable of bidirectional transmission, it may send a request to receive a designation for an unpaired downlink traffic channel.

A sixth aspect of the present invention is directed to a CDMA or TDMA mobile receiver for receiving unidirectional transmission from fixed servers. The mobile receiver comprises a selection logic used for selecting a first server and for selecting a neighbor server when the neighbor server is received with higher signal quality than the first server. The mobile receiver comprises a decoder for decoding data. Data may take the form of voice, video or packet data services. The mobile receiver optionally comprises means for bidirectional communication and, if such means are comprised, a switch for turning on or off transmission capabilities.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) shows a mobile receiver and two proximally located Radio Base Stations;

FIG. 2 shows an exemplary mobile receiver built according to preferred embodiment of the present invention;

FIG. 3a shows an exemplary method implementing the preferred embodiment of the present invention; and

FIG. 3b shows a variant of the method implementing the preferred embodiment of the present invention;

FIG. 3c shows another variant of the method implementing the preferred embodiment of the present invention wherein an optional request for unidirectional service is sent by another exemplary mobile receiver; and

FIG. 4 shows an exemplary use of the method and of the mobile receiver of the present invention.

### DETAILED DESCRIPTION OF THE PREFERRED EMBODIMENT

The innovative teachings of the present invention will be described with particular reference to various exemplary uses and aspects of the preferred embodiment. However, it should be understood that this embodiment provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the following description, the terms “Radio Base Station (RBS)” and “server” may be used to represent the same concept of a node comprising at least one broadcast channel and at least one traffic channel providing service over a same coverage area or cell.

Mobile networks are increasingly used for new services that were not predicted at the time when conventional concepts such as Mobile Assisted Hand Off (MAHO) were defined. One service concept that could be of great interest is the capability to broadcast data on a continuous basis, intended to a plurality of concurrent users. Examples of such data may comprise video, audio information such as news, tourist information, music and the like. Such capability could use unidirectional transmission wherein a downlink traffic channel is used without being paired with a reverse, or uplink, traffic channel. The present invention provides a solution for enabling cell reselection, or handoff, from a first cell to a neighboring cell while using unidirectional transmission from a RBS to a mobile receiver. The present invention is especially applicable in cases where the content to be broadcasted is either large or continuous, as prior art methods such as broadcast Short Message Service (SMS) are not well suited to carry such content. Because mobile receivers are not transmitting, they do not generate interference. Also, unidirectional transmission from a server may be received by any number of mobile receivers. A single server built according to the preferred embodiment of the present invention can thus serve an unlimited number of mobile receivers.

The present invention provides a method and a mobile receiver for providing a content, for instance an audio signal, streaming video or packet data, to a user of a mobile receiver without the use of a reverse traffic channel. The invention supports both mobile terminals capable of bidirectional communication and mobile terminals that only have receiving capabilities. Since a receive-only capable mobile receiver does not send any request for expressly requesting unidirectional service from the RBS, a broadcast channel repetitively sends unpaired downlink traffic channel designations for use by an eventual mobile receiver ready to receive service. In the case of a bidirectional capable mobile receiver, either the broadcast channel unpaired downlink traffic channel designation, which is intended to a plurality of mobile users, or an unpaired downlink traffic channel designation dedicated to this specific bidirectional capable mobile terminal may be used. As the user moves around, reception quality from the unpaired downlink traffic channel may degrade and a handoff to a new server may be appropriate. Moreover, as the user moves, it may become advantageous to change the content of the unidirectional service of interest to the user. For instance, in a case where the user is located proximate to a first server, he/she receives a content from said first server. If the user moves closer to a second server, he/she would desire to receive a content from the second server. In order to maintain unidirectionality of the communication, the well-known handoff mechanisms of conventional mobile cellular networks are replaced in the present invention by an autonomous process effectuated in the mobile receiver. The mobile receiver makes autonomous decisions to select the most appropriate server among a list of available servers. The autonomous decision process relies on signal quality evaluation capabilities of the mobile receiver.

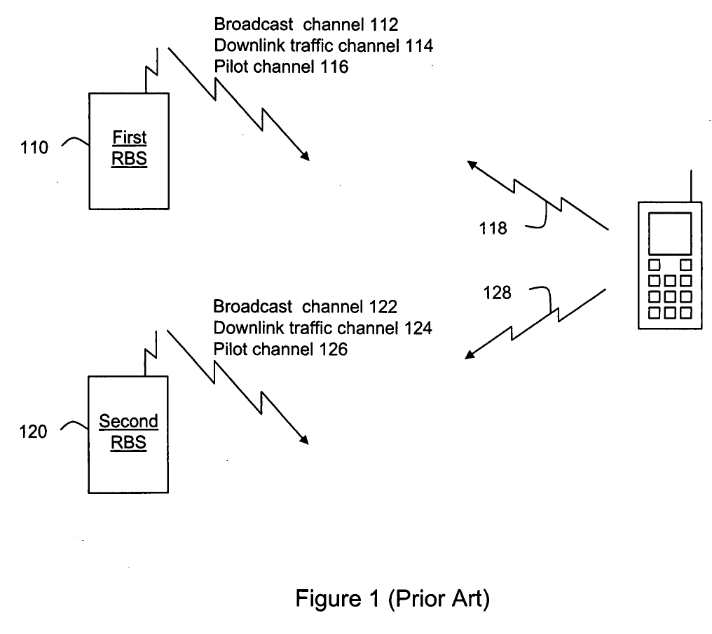

Referring once again to FIG. 1, which shows a mobile receiver and two proximally located Radio Base Stations, the mobile terminal 100 has a capability of evaluating the signal strength of downlink channels in the cell it is currently selecting as well as the signal strength of downlink channels in the neighboring cells. Conventionally, as the mobile terminal 100 moves around between cells, reselection of the best connection is effectuated, unbeknownst to the user. Two distinct cases apply and are based on principles that are mostly common to Code Division Multiple Access (CDMA) and to Time Division Multiple Access (TDMA) mobile communication.

Firstly, while the user is not involved in a call, the mobile terminal 100 is in standby mode. In standby mode, the mobile terminal 100 is monitoring the broadcast information received on the TDMA control channel 112 or 122 or on the CDMA paging channel 112 or 122. At the time, communication is unidirectional most of the time, unless a brief event happens such as when the user initiates a call or when the mobile terminal 100 responds to a dedicated message, such as a page. In standby mode when none of those events occur, the mobile terminal 100 is only receiving and is not transmitting. By not transmitting, the mobile terminal 100 is also not generating any radio interference. At the same time, while in standby mode, the mobile terminal 100 evaluates the received signal strength on a downlink channel in the present cell as well as that of the neighboring cells. A TDMA mobile terminal 100 evaluates the signal strength of the present cell's control channel 112 and 122 and the signal strength of the neighboring cells' measurement channels. A CDMA mobile terminal 100 evaluates the present cell as well as neighbor cells by measuring the signal strength on their respective pilot channels 116 and 126, which are used in CDMA as measurement channels. As the user moves around between coverage areas of cells while in standby mode, if the mobile terminal 100 determines that the signal strength of a new cell has become stronger than the signal strength of the present cell, the mobile terminal 100 selects the new cell and starts monitoring the new cell's broadcast information.

Secondly, while the user is in an active voice or data call, it holds a dedicated traffic channel pair, said dedicated traffic channel pair being unavailable to serve any other mobile terminal 100 within a large area comprising many cells. While holding a dedicated traffic channel pair, the mobile terminal 100 is busy. In TDMA, the dedicated traffic channel pair comprises a timeslot on a downlink frequency and the same timeslot of a corresponding uplink frequency, said timeslot and said frequencies forming a combination dedicated to that mobile terminal 100, said combination not being reused in any surrounding cells. In CDMA, the dedicated traffic channel pair comprises a frequency pair shared between many users and preferably shared between many cells, a pair of channelization codes, one in the forward link direction and one in the reverse link direction, dedicated to that mobile terminal 100 in that cell, and a pseudo random sequence specific to the cell. Because the number of available traffic channels is limited, the dedication of traffic channels to specific mobile terminals for the purposes of specific calls is one of the main factors limiting the traffic capacity of mobile networks. While busy, the mobile terminal 100 decodes the content received on the TDMA downlink traffic channel 114 or 124 or on the CDMA downlink traffic channel 114 or 124. The mobile terminal 100 also transmits towards the RBS on the TDMA or CDMA uplink traffic channel 118 or 128. Because it is transmitting on the uplink traffic channel 118 or 128, the mobile terminal 100 generates radio interference. In a mobile network comprising a large number of mobile terminals, many simultaneous reverse link traffic channel 118 and 128 transmissions from mobile terminals interfere with each other. This interference phenomenon is another main factor limiting the traffic capacity of the mobile network. While receiving on the dedicated forward link traffic channel 114 or 124, the mobile terminal 100 evaluates the received signal strength in the present cell as well as that of the neighboring cells. As a busy terminal 100 moves around between coverage of cells while busy, it transmits on the reverse link traffic channel information regarding the signal strength of the present cell and the signal strength of the neighboring cells, said information being based on measurements made in a manner that is essentially the same as the hereinabove described method used for making neighboring cell measurements while in standby mode. Despite the capability of the mobile terminal 100 to make measurements of signal quality in the present cell and in surrounding cells, the mobile terminal 100 is not allowed to make a decision on a cell reselection. The reasons are two-fold. First, the mobile terminal 100 does not know if any free traffic channel pair is available in the new cell as well as it does not know the identity (frequency and timeslot combination in the case of TDMA, frequency, channelization code and pseudo random sequence combination in the case of CDMA) of any traffic channel pair eventually available in the new cell. If the mobile terminal 100 was allowed to autonomously select a new cell, it would have to make a request to obtain a designation for a new traffic channel pair. This step would cause a pause of several seconds in the communication, which would be detrimental to most voice or data services. Second, as the mobile terminal 100 generates reverse link interference, it cannot make any estimation of an impact in terms of reverse link interference caused by a choice of a specific traffic channel pair. The mobile communication network is the only entity that is capable of making a full assessment of the impacts on interference of allocating traffic channel pairs to mobile terminals. As a result, it is conventional to use mobile terminal 100 for providing signal strength measurements solely as a means to assist cell reselection by mobile communication networks, by use of Mobile Assisted Hand Off (MAHO). A network node in control of the RBSs takes any handoff decision based in part on the MAHO measurements of the mobile terminal 100. When the network node has taken the handoff decision, a designation for a traffic channel pair is sent to the mobile terminal 100.

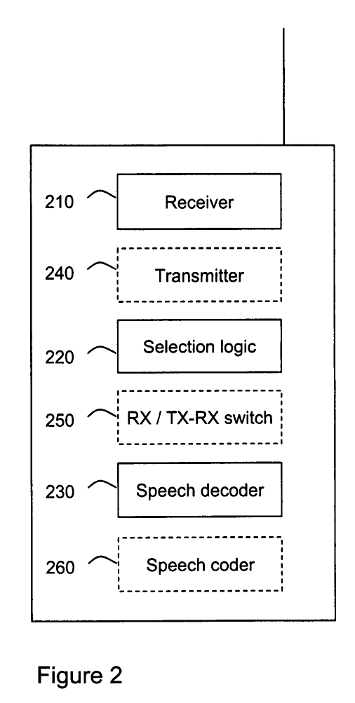

Referring now to FIG. 2, an exemplary mobile receiver 200 built according to the preferred embodiment of present invention is shown. The mobile receiver 200 comprises a receiver 210, a selection logic 220 and a speech decoder 230. The mobile receiver 200 may optionally comprise a transmitter 240, a switch 250 and a speech coder 260, as these optional elements bring to the mobile receiver 200 transmission capabilities enabling it to alternate between receive-only or transmit-receive modes. The mobile receiver 200 may further comprise many more components of a standard mobile terminal, as well known by those of ordinary skills in the art. In the case where the mobile receiver 200 comprises the optional transmitter 240, switch 250 and speech coder 260, the mobile receiver may additionally operate as a standard mobile terminal for bidirectional communication with a mobile network. When the switch 250 is in transmit-receive mode, the transmitter 240 and the speech coder 260 are enabled and the mobile receiver 250 operates as any standard mobile terminal. When the switch 250 is in receive-only mode, the mobile receiver 250 operates in unidirectional reception mode according to the teachings of the present invention.

The receiver 210 may be a conventional receiver as described by the IS-136 TDMA air interface standard, by the GSM air interface standard which also is a form of TDMA, by the IS-95 CDMA air interface standard, by the CDMA200 air interface standard, or by the Wideband Code Division Multiple Access (WCDMA) air interface standard. The receiver 210 receives the downlink traffic channel. Likewise, the transmitter 240 and the speech coder 260, if included, are conventional and are also built according to the relevant air interface standard. The optional transmitter 240, when present, may be used to transmit on the uplink traffic channel, otherwise known as reverse traffic channel, when the mobile receiver 200 is used for other services than the unidirectional service. The speech decoder 230 is also conventional.

The selection logic 220 used for cell selection differs from a conventional means found in a standard mobile terminal, such means normally being used for MAHO. If the mobile receiver 200 comprises the optional transmitter 240 and the optional switch 250, the selection logic 220 comprises MAHO capabilities. In any case, the selection logic 220 further comprises capabilities store server information comprising a measurement channel for each server and to autonomously determine when a server shall be selected, both for receiving a broadcast channel and for receiving an unpaired downlink traffic channel. Selection of the server is accomplished by an evaluation of a quality of the servers. Quality of the servers may be evaluated by use of signal strength measurements on downlink channels, analysis of signal-to-noise ratio on received signals, measurement of bit-error-rates, and the like.

While FIG. 2 shows a terminal comprising the speech decoder 230 and the optional speech coder 260, the terminal may comprise other mechanisms to encode, decode or otherwise use and process traffic channel information. Instead of or in addition to the speech decoder 230 and speech coder 260, the mobile receiver 200 may comprise a video decoder and a video coder, or a packet handler for treatment of received packet data information and, if the mobile terminal 200 is bidirectional capable, for preparation of packet data information to be transmitted.

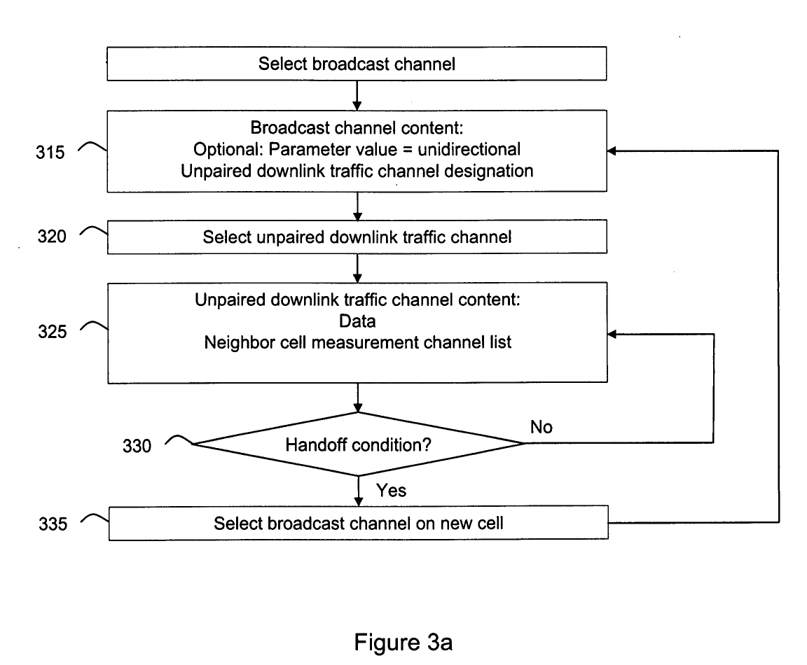

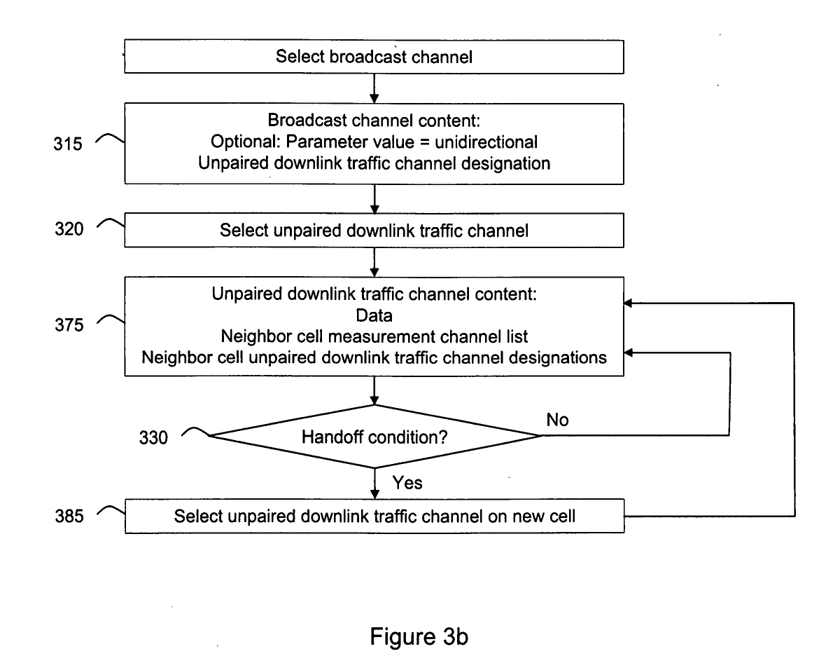

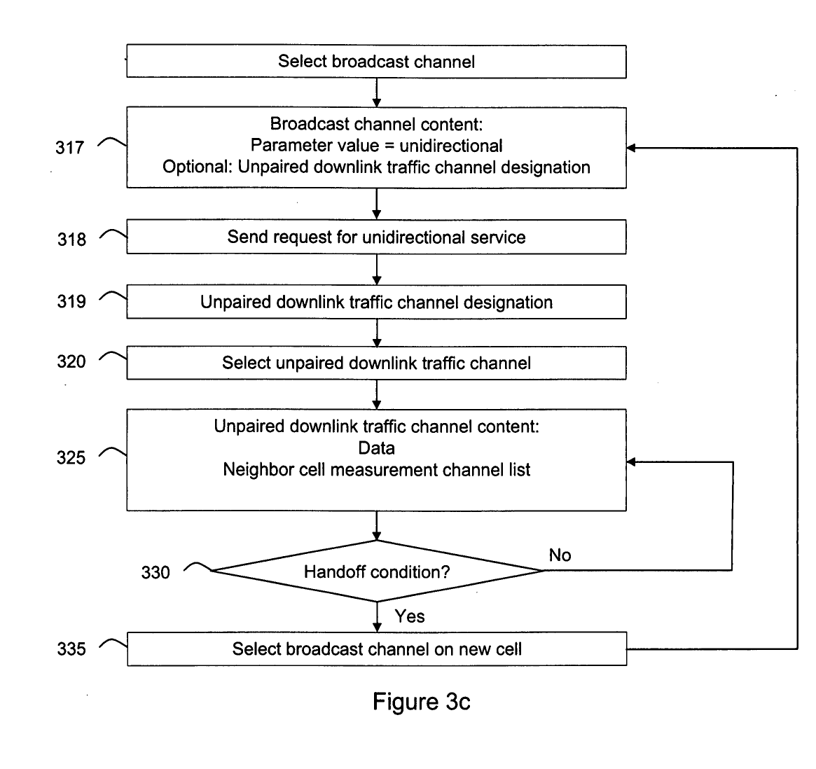

Referring now to FIG. 3a which shows an exemplary method implementing the preferred embodiment of the present invention, the mobile receiver selects a downlink broadcast channel at step 300. Particulars of step 300 vary slightly depending on whether the mobile receiver is a standard mobile terminal or whether the mobile receiver comprises receive-only capabilities. The selection logic 220 operates, when the mobile receiver 200 is not receiving data on a traffic channel, to select the broadcast channel with the highest signal quality among possible broadcast channels. The mobile receiver 200 may find a broadcast channel according to general principles for selecting broadcast channels as described in the air interface standard from which it borrows its elements, said air interface standard comprising any of TDMA IS-136, GSM, CDMA2000, CDMA IS-95 or WCDMA. Alternatively, the selection logic 220 may comprise a pre-set list of possible broadcast channels; the list of possible pre-set broadcast channels typically comprises a small number of broadcast channels specific to cells of an application, such as for example a private network using the unidirectional reception capability of mobile receiver 200. In this case, the receiver 210 simply monitors all broadcast channels sequentially to select a first broadcast channel with a good signal quality, as for example a first broadcast channel with sufficient signal strength for proper reception. The mobile receiver 200 may receive on the first broadcast channel a list of neighboring broadcast channels that the terminal may monitor. The mobile receiver 200 then compares the signal quality of each broadcast channel, on the present cell as well as on the neighboring cells. If the mobile receiver 200 determines that another server provides a better signal quality, it tunes to a broadcast channel of that server. Eventually, comparisons of signal quality on broadcast channels leads the mobile receiver 200 to select the broadcast channel at step 300.

Considering now step 315, the mobile receiver 200 decodes the broadcast channel content. The broadcast channel may transmit an optional parameter indicating to the mobile receiver 200 that the cell supports downlink unidirectional transmission on at least one traffic channel. In the case of a fully private network wherein all mobile receivers 200 are used for such unidirectional transmission service and wherein the cell only support said type of service, the unidirectional transmission is implied and the parameter indicating unidirectional transmission is not required.

To receive unidirectional service, the mobile receiver 200 needs to get access to an unpaired downlink traffic channel. This can be accomplished in various manners. In one aspect of the present invention particularly suited to a network wherein the cell only provides unidirectional service, the broadcast channel periodically transmits an unpaired downlink traffic channel designation message, said message having the particularity of not being dedicated to any specific user, rather being intended to any mobile receiver 200 able to use the unidirectional service. The unpaired downlink traffic channel designation comprises a frequency and a timeslot in the case of TDMA, or a frequency, an orthogonal code and a pseudo-random sequence in the case of CDMA. The periodicity of the unpaired downlink traffic channel designation is selected so that the user will not need to wait for an excessive length of time before getting access to the unidirectional service, also considering that an excessive rate of sending the unpaired downlink traffic channel designation would require an excessive amount of bandwidth on the broadcast channel. The periodicity may be for example in a range of every few tenths of a second to every few seconds. In the case of periodic unpaired downlink traffic channel designations on the broadcast channel, the mobile receiver 200 simply waits while receiving the broadcast channel until it detects the unpaired downlink traffic channel designation. Upon receiving the unpaired downlink traffic channel designation, the mobile receiver 200 selects the unpaired downlink traffic channel.

Information is required at the mobile receiver 200 to specify that the traffic channel is to be used in the forward link only. In a case where the cells and the mobile receivers 200 form a private network independent from any other network, the information that all traffic channel communication is unidirectional in the forward link, or downlink, is implemented by pre-programming of the mobile receivers 200. Unidirectionality may also be implied by the sheer fact that all mobile receivers 200 are only capable of unidirectional communication in the private network. In an alternate aspect of the present invention particularly suited to provide unidirectional service as an optional feature in a standard mobile network also capable of bidirectional service, the broadcast channel may transmit a designation of a traffic channel, said designation comprising a specific indication that the traffic channel is unidirectional, used in the forward link only. The unpaired downlink traffic channel designation may be intended to one specific mobile receiver 200, to a specific group of mobile receivers 200 or to any mobile receiver 200 capable of unidirectional communication. Since the indication is provided to the mobile receiver 200 by the addition of a parameter specifying unidirectional transmission, the traffic channel designation message may differ from a standard traffic channel designation message.

Having received the unpaired downlink traffic channel designation by any of the aforementioned methods at step 315, the mobile receiver 200 selects the unpaired downlink traffic channel at step 320 and starts receiving the content of the unpaired downlink traffic channel at step 325. Any optional transmitter 240 and speech coder 260 in the mobile receiver 200 are switched off or otherwise inactivated. The optional switch 250, if present, is set in the receive-only mode. Still at step 325, the mobile receiver 200 receives data, for instance a voice recording, which is decoded in the speech decoder 230. At the same time, the mobile receiver receives neighbor server information on the unpaired downlink traffic channel in the form of a neighbor server measurement channel list. In an alternate aspect of the preferred embodiment, in the case of a private network, the aforementioned list of pre-set broadcast channels implemented in the selection logic 200, as described at step 300 above, may be used as a substitute for the neighbor server measurement channel list received on the unpaired downlink traffic channel.

At step 330, the mobile receiver 200 compares a received signal quality on the present cell with signal quality values of neighboring cells. In the case of TDMA, the selection logic 220 considers a received signal quality on the unpaired downlink traffic channel that the receiver 210 currently receives. In the case of CDMA, the selection logic 220 considers a pilot signal quality on the cell also comprising the unpaired downlink traffic channel that the receiver 210 currently receives. The selection logic 220 also considers signal quality estimations made at the receiver 210 on measurements channels of neighboring cells. Estimations of signal quality of the present cell and of signal quality of the neighboring cells may be done in the same manner as a standard mobile terminal built according to the relevant TDMA or CDMA air interface standard, by use of signal strength measurements. Estimations of signal quality of the present cell and of signal quality of the neighboring cells may also be done by other means such as estimation of bit-error rates, signal to noise-ratio, distortion measurements and the like. In the case of TDMA, any radio channel may be a measurement channel. In the case of CDMA, a measurement channel for a cell is a pilot channel in that cell. Preferably, signal quality estimates are averaged over a brief pre-defined period of time in order to compensate for radio propagation effects such as shadowing and Rayleigh fading and for imprecise measurements. Averaging may be made over a brief pre-defined period corresponding to a small number of TDMA frames or CDMA frames, usually on the order of a few tenths of a second up to one second. Preferably, when signal strength comparisons are used, these are made factoring in a hysteresis value, added to the signal strength value for the present cell. The hysteresis value used to avoid rapid reselections back and forth between cells received with similar signal strengths is, for example, in a range of 1 to 3 dB. If the current cell still provides the best signal strength, there is no handoff condition and the process continues at step 325. If a neighbor server provides better signal quality, there is a handoff condition found at step 330. The process moves to step 335 where the mobile receiver 200 selects the broadcast channel of the new cell. The process then continues at step 315 where the mobile receiver 200 waits for a periodic unpaired downlink traffic channel designation. Alternatively, if the system does not support periodic unpaired downlink traffic channel designations, a bidirectional capable mobile receiver 200 sends a request on the broadcast channel to receive a dedicated unpaired downlink traffic channel designation.

In conventional networks using conventional methods, a traffic channel is dedicated to each user. Any number of mobile receivers may at once receive the same data on the unpaired downlink traffic channel of the present invention. Hence, in a given cell, one single high bandwidth traffic channel may be allocated for unidirectional transmission from the server towards a large number of mobile receivers. Because only one such high bandwidth unpaired downlink traffic channel may be required, a high level of error detection and error correction encoding may be added to the data. As a result, data can be reliably transmitted to the mobile receivers without the aid of reverse link feedback from the mobile receivers.

Referring now to FIG. 3b, a variant of the method implementing the preferred embodiment of the present invention is shown. Steps 300, 315, 320 and 330 are the same as those shown in FIG. 3a. At step 375, the mobile receiver 200 receives the same data and the same neighbor server measurement channel list, as described in the aforementioned description of step 325. In addition, the mobile receiver 200 receives at step 375 additional neighbor server information in the form of downlink traffic channel identities for each of the neighboring cells. The downlink traffic channel identity comprises the same information as the unpaired downlink traffic channel designation message described at step 315. The mobile receiver 200 does not immediately use it for selecting a downlink traffic channel. The neighboring cell data format of step 375, with the addition of downlink traffic channel identities, comprises all required information for the mobile receiver 200 to select the unpaired downlink traffic channel of each of the neighbor servers. Comparison of signal quality evaluations on the present cell and on neighboring measurement channels is performed at step 330 in order to determine whether a handoff condition exists. If no handoff condition is present, the process continues at step 375. If a handoff condition is found, the process continues at step 385 where the cell corresponding to the measurement channel received with the highest signal quality is selected. The downlink traffic channel identity having been received earlier in the mobile receiver 200 at step 375, the mobile receiver 200 immediately selects the unpaired downlink traffic channel on the new cell at step 385. The process continues on the new unpaired downlink traffic channel at step 375 where data is received from the new unpaired downlink traffic channel and where neighbor server information relative to the new cell is received. While in this case, the continuous transmission of enhanced neighboring cell data requires more bandwidth on the unpaired downlink traffic channel, the advantage of this alternate aspect of the present invention is that acquisition of the new unpaired downlink traffic channel is faster than as depicted in the description of FIG. 3a.

Reference is now made to FIG. 3c which shows another variant of the method implementing the preferred embodiment of the present invention wherein an optional request for unidirectional service is sent by another exemplary mobile receiver. This exemplary mobile receiver 200 is capable of bidirectional communication. Steps 300, 320, 325, 300 and 335 are identical to the same steps in FIG. 3a. At step 317, the mobile receiver 200 decodes the broadcast channel content. In the variant of the method of FIG. 3c, the broadcast parameter indicating to the mobile receiver 200 that the cell supports unidirectional transmission service on at least one traffic channel is required. The mobile receiver 200, responsive to the broadcast parameter indicating support of unidirectional transmission, sends to the server a request to get access to unidirectional service at step 318. In this case, the server responds by sending an unpaired downlink traffic channel designation at step 319, said message being intended solely to the mobile receiver 200 having requested access to unidirectional service. In a system that only supports such bidirectional capable mobile receivers 200, use of the periodic broadcast unpaired downlink traffic channel designation at step 317 is possible, but not required. The mobile receiver 200 selects the unpaired downlink traffic channel at step 320 and further operates in the same manner as shown in FIG. 3a. One of the advantages of using the optional request from the mobile receiver 200 prior to assigning an unpaired downlink traffic channel designation is the possibility to charge for the service since a record may be kept of such requests. The unpaired downlink traffic channel designation, or the data, when dedicated to a given mobile receiver 200, may be encrypted. Encryption ensures that only those users that have made proper requests can have access to the service.

FIG. 3c has been shown as a variant of the exemplary method of FIG. 3a. It should however be understood that the exemplary method of FIG. 3b could also be modified to support the bidirectional mobile receiver 200 capable of sending a request to get access to unidirectional service. Hence, steps 375 and 385 as shown on FIG. 3b could replace steps 325 and 335 in the variant of the method described in FIG. 3c.

With either of the methods of FIGS. 3a, 3b or 3c, data in different cells may be identical or distinct. In an application where it is desired to provide data such as a news broadcast, to users in a large area, the same data is preferably provided in each cell. In another application where it is desired to provide data specific to the user's location, data may differ in each cell.

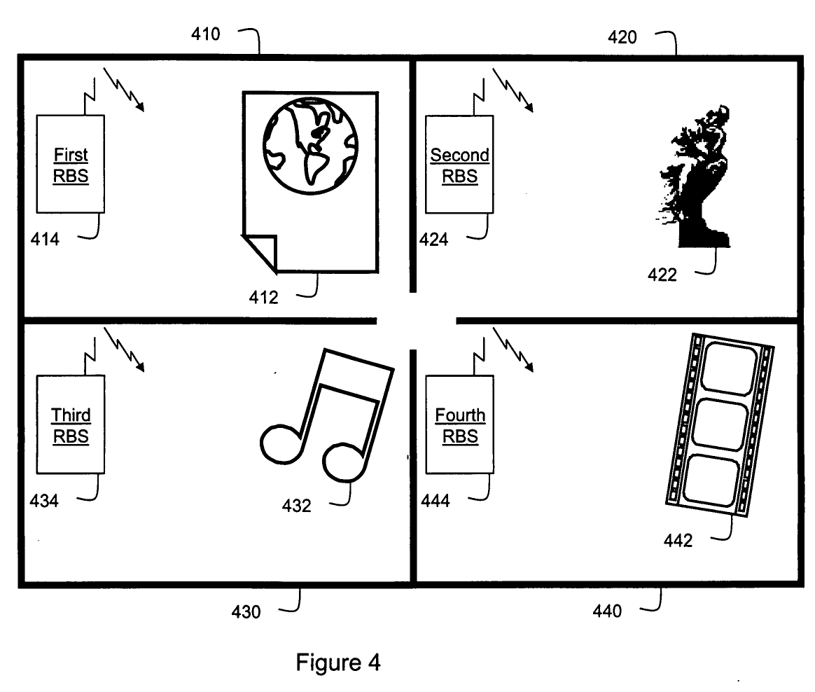

Referring now to FIG. 4, an exemplary use of the method and the mobile receiver of the present invention is illustrated. FIG. 4 shows an art exhibition hall 400 comprising four (4) distinct sections, such as rooms 410, 420, 430 and 440, wherein artifacts 412, 422, 432 and 442 are on display. At a conventional art exhibition, a guide would greet visitors and provide explanations on the various artifacts as visitors tour the art exhibition. Sometimes, other means are substituted for the guide. For instance, headphones may be installed near each artifact for use by the visitors as they peruse over the displays. Alternatively, tape players with headphones may be rented by visitors as they enter the exhibition hall. All of those manners of providing information have their drawbacks: Use of guides, though more personal, is costly, requires planning, may require knowledge of more than one language by the guides, and forces visitors to follow scheduled groups. Use of headphones at fixed locations may force visitors to wait when all headphones at a specific location are in use. Use of tape players may require users to move at a preset pace, consistent with the programmed content.

Using the method and the mobile receiver of the present invention overcomes all of those deficiencies. RBSs 414, 424, 434 and 444 are placed in rooms 410, 420, 430 and 440 in order to support unidirectional transmission. Upon entering the exhibition hall, the visitor may be offered the use of a mobile receiver from a pool of available units. A receiving-only mobile receiver used solely in the exhibition hall facilities is pre-programmed to select a first broadcast channel amongst a limited set of channels corresponding to RBSs 414, 424, 434 and 444. If the visitor owns a bidirectional capable mobile terminal capable of unidirectional reception, as per the preferred embodiment of the present invention, he/she may use this terminal as a mobile receiver. The mobile terminal capable of bidirectional communication can be put in receive-only mode by use of a code entered by the user. The exhibition hall staff can give instructions to the visitor on which particular code is required to access the servers used in the exhibition. The mobile terminal can also be put in the receive-only mode by other means, for example, an SMS may be received by the mobile terminal, indicating that unidirectional communication is possible. The SMS may further comprise a list of one or more broadcast channels used for unidirectional communication. The user may then press a single button on the mobile terminal to indicate whether or not he/she wants to use the unidirectional communication service. In any cases, for comfort and convenience, use of a hands free earpiece is preferable.

As the visitor enters a first room 410 in the exhibition hall, the mobile receiver selects the broadcast channel of the first RBS 414 currently transmitting in the first room 410. This selection is made simply because a signal from first RBS 414 is received with a better signal quality than signals from any other RBS in the exhibition hall. By use of one of the methods introduced in the foregoing description of FIGS. 3a and 3b, the mobile receiver receives an unpaired downlink traffic channel designation from the first RBS 414. In this exemplary use, the unpaired downlink traffic channel of the first RBS 414 includes a recorded voice description of the artifacts 412 found in the first room 410. When the visitor decides to moves to the second room 420, the mobile receiver rapidly detects that the measurement channel of the second RBS 424 found in the second room 420 has become stronger. The mobile receiver thus starts receiving an unpaired downlink traffic channel from the second RBS 424, said unpaired downlink traffic channel comprising a different recorded voice description describing the artifacts 422.

In yet another aspect of the preferred embodiment of the present invention, the method and mobile receiver can be used in any standard mobile communication network having been adapted to the teachings of the present invention. One or several traffic channels may be set aside in a cell or in any number of cells to support unidirectional transmission. A broadcast parameter may be used to inform mobile terminals having the features of the present invention that downlink unidirectional transmission is available. Traffic channel designations for unpaired downlink traffic channels may be sent periodically on the broadcast channel of the cell or cells having unpaired downlink traffic channels to let mobile receivers select the unidirectional service. Alternatively, a bidirectional capable mobile terminal may, as directed by the user, send a request for traffic channel designation to the unidirectional service. The unidirectional service is not limited to voice or audio information, but may also comprise video or packet data service.

Although several aspects of the preferred embodiment of the method and of the distributor of the present invention have been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. A method for autonomous handoff control in support of unidirectional transmission from fixed servers to a mobile receiver, comprising the steps of:
a) providing said mobile receiver with neighbor server information, said neighbor server information comprising one or more neighbor measurement channels for one or more neighbor servers;
b) receiving data at said mobile receiver over an unpaired downlink traffic channel;
c) evaluating at said mobile receiver a received signal quality of a channel of said first server;
d) evaluating at said mobile receiver a received signal quality of each of said neighbor measurement channels;
e) comparing at said mobile receiver said received signal quality of said channel of said first server with said received signal quality of each of said neighboring measurement channels; and
f) when said mobile receiver determines that a measurement channel for a second server has a higher signal quality than said signal quality of said first server, selecting said second server at said mobile receiver.

2. The method of claim 1, wherein:
step a) comprises receiving said neighbor server information over said unpaired downlink traffic channel.

3. The method of claim 1, wherein:
said signal quality of said channel of said first server and said signal quality for each of said neighbor measurement channels are signal strength measurements.

4. The method of claim 3, wherein:
step c) and step d) comprise averaging signal strength measurements over a pre-defined period; and
step e) comprises adding a hysteresis value to the signal strength measurement for said first server.

5. The method of claim 1, further comprising the step of receiving at said mobile receiver a designation for an unpaired downlink traffic channel from said first server.

6. The method of claim 1, further comprising, after step f), the step of receiving an unpaired downlink traffic channel designation from said second server.

7. The method of claim 1, wherein:
said neighbor server information further comprises a downlink traffic channel identity for each of said neighbor server; and
step f) comprises selecting a downlink traffic channel identity for said second server.

8. The method of claim 1, wherein:
said first server and said second server use Code Division Multiple Access (CDMA) transmission;
said one or more neighbor measurement channels comprises a pilot channel for one or more neighboring servers; and
step c) comprises evaluating a signal quality of a pilot channel of said first server.

9. The method of claim 1, wherein:
said first server and said second server use Time Division Multiple Access (TDMA) transmission; and
step c) comprises evaluating a signal quality of said unpaired downlink traffic channel.

10. The method of claim 1, wherein:
said data and additional data on said one or more neighbor servers are identical.

11. The method of claim 1, wherein:
said data and additional data on said one or more neighbor servers are distinct.

12. The method of claim 1, wherein:
said mobile receiver comprises a decoder for decoding said data.

13. The method of claim 1, wherein:
said mobile receiver comprises transmission capabilities.

14. The method of claim 10, wherein:
said mobile receiver transmits a request for unidirectional service towards said first server; and
said unpaired downlink traffic channel designation is received responsive to said request for unidirectional service sent by said mobile receiver.

15. The method of claim 14, wherein:
said unpaired downlink traffic channel is encrypted.

16. A mobile receiver for autonomous handoff control in support of receiving unidirectional transmission from fixed servers comprising:
a receiver for receiving a designation for an unpaired downlink traffic channel from a first server;
said receiver for receiving data over said unpaired downlink traffic channel;
a decoder for decoding said data;
a selection logic for storing neighbor server information, said neighbor server information comprising one or more neighbor measurement channels for one or more neighbor servers;
said receiver for evaluating a signal quality of said first server;
said receiver for evaluating a signal quality on each of said neighbor servers; and
said selection logic for selecting a second server when said second server provides a higher signal quality than said first server.

17. The mobile receiver of claim 16, wherein:
said receiver receives neighbor server information over said unpaired downlink traffic channel.

18. The mobile receiver of claim 16, wherein:
said signal quality of said first server and said signal quality on each of said neighbor servers are signal strength measurements.

19. The mobile receiver of claim 16, wherein:
said mobile receiver uses Code Division Multiple Access (CDMA) reception.

20. The mobile receiver of claim 16, wherein:
said mobile receiver uses Time Division Multiple Access (TDMA) transmission.

21. The mobile receiver of claim 16, wherein:
said decoder is a speech decoder for decoding said data and for producing an audio signal.

22. The mobile receiver of claim 16, wherein:
said decoder is a video decoder for decoding said data and for producing a video signal.

23. The mobile receiver of claim 16, further comprising:
a packet handler.

24. The mobile receiver of claim 16, further comprising:
transmission capabilities.

25. The mobile receiver of claim 24, further comprising:
a switch for inactivating said transmission capabilities, responsive to an indication that unidirectional transmission is used on said first server.
